(19) United States
(12) Patent Application Publication
(10) Pub. No.: US 2016/0192094 A1
(43) Pub. Date: Jun. 30, 2016

(54) DEVICE FOR PLAYING MUSIC AND CONTROL METHOD THEREOF

(71) Applicant: Quanta Computer Inc., Taoyuan City (TW)

(72) Inventor: Chien-Hung LIU, Taoyuan City (TW)

(73) Assignee: Quanta Computer Inc., Taoyuan City (TW)

(21) Appl. No.: 14/669,772

(22) Filed: Mar. 26, 2015

(30) Foreign Application Priority Data
Dec. 26, 2014 (TW) 103145776

(51) Int. Cl. H04R 27/00

(52) U.S. Cl. CPC H04R 27/00; H04R 2420/07

(57) ABSTRACT

A device for playing music includes a maglev unit and a base unit. The maglev unit outputs a first sound signal based on a physical signal corresponding to an original sound signal. The base unit provides the physical signal to the maglev unit via a first wireless transmission, and outputs a second sound signal based on the original sound signal. The base unit includes a maglev control module, a power supply module and a processor. The maglev control module generates a magnetic force according to a first current to make the maglev unit float on the base unit. When the first current is continuously within a predetermined current range for a predetermined time duration, the processor controls the power supply module to output the first current, and to supply an electrical energy to the maglev unit via a second wireless transmission that is different from the first wireless transmission.

### RELATED APPLICATIONS

This application claims priority to Taiwan Application Serial Number, 103145776, filed Dec. 26, 2014, which is herein incorporated by reference.

### BACKGROUND

1. Technical Field

The present disclosure relates to an electronic device. More particularly, the present disclosure relates to a device for playing music, in which the device for playing music has a maglev function.

2. Description of Related Art

With the development of technology, various types of devices for playing music, such as portable music players and cloud music player systems, have become increasingly popular.

In recent years, a maglev music system that has both practicality and a good appearance has been developed. Utilizing magnetic force characteristics, the maglev music system is able to make a loudspeaker float on a woofer, and thus a special external appearance and the ability to output sound via different channels can be achieved.

However, in the present maglev music system, the loudspeaker must be charged in advance to perform the floating and music-playing operations, resulting in the playback time of the maglev music system being reduced. In addition, since there is interference between the magnetic force and music transmission, the resolution of the sound output from the maglev music system cannot be increased.

### SUMMARY

An aspect of the present disclosure is to provide a device for playing music. The device includes a maglev unit and a base unit. The maglev unit is configured to output a first sound signal based on a physical signal corresponding to an original sound signal. The base unit is configured to provide the physical signal to the maglev unit via a first wireless transmission, and to output a second sound signal based on the original sound signal. The base unit includes a maglev control module, a power supply module and a processor. The maglev control module is configured to generate a magnetic force according to a first current, so as to make the maglev unit float on the base unit. The power supply module is configured to supply power to the maglev control module. The processor is configured to control the power supply module to output the first current, and to control the power supply module to supply an electrical energy to the maglev unit via a second wireless transmission when the first current is continuously within a predetermined current range for a predetermined time duration. The first wireless transmission and the second wireless transmission are different.

Another aspect of the present disclosure is to provide a control method for controlling a device for playing music. The device includes a maglev unit and a base unit. The control method includes the following steps: generating a magnetic force by a maglev control module of the base unit according to a first current, so as to make a maglev unit float on the base unit; providing a physical signal corresponding to an original sound signal by the base unit to the maglev unit via a first wireless transmission, in which the maglev unit is configured to output a sound signal according to the physical signal; and supplying electrical energy by a power supply module of the base unit to the maglev unit via a second wireless transmission when the maglev unit stably floats on the base unit, in which the first wireless transmission and the second wireless transmission are different.

In summary, the device for playing music of the present disclosure utilizes different wireless transmissions to transmit electrical energy and music at the same time, and thus achieves a high resolution and a long playback time. Further, by continuously detecting variations in internal currents, the reliability of the device for playing music can be improved.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a device for playing music according to one embodiment of the present disclosure;

FIG. 2 is a schematic diagram of a device for playing music according to one embodiment of present disclosure;

FIG. 3A is a circuit diagram of an optical communication transmitter according to one embodiment of the present disclosure;

FIG. 3B is a circuit diagram of an optical communication receiver according to one embodiment of the present disclosure; and

FIG. 4 is a flow chart of a control method according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Although the terms “first,” “second,” etc., may be used herein to describe various elements, these elements should not be limited by these terms. These terms are used to distinguish one element from another.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

In this document, the term “coupled” may also be termed as “electrically coupled,” and the term “connected” may be termed as “electrically connected”. “Coupled” and “connected” may also be used to indicate that two or more elements cooperate or interact with each other.

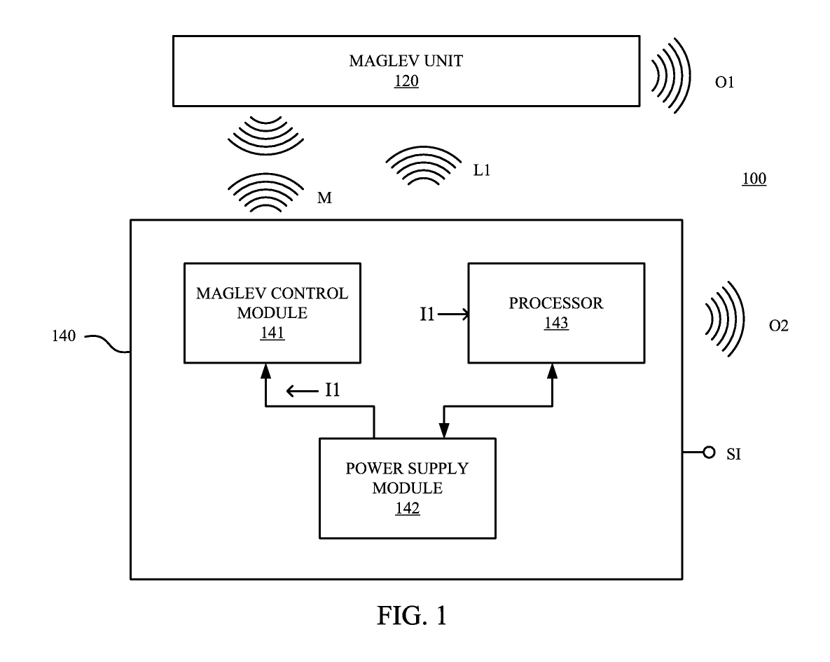

FIG. 1 is a schematic diagram of a device for playing music according to one embodiment of the present disclosure. As shown in FIG. 1, the device 100 includes a maglev unit 120 and a base unit 140.

The maglev unit 120 is disposed corresponding in location to the base unit 140, and is floating on the base unit 140 by a magnetic force M. The maglev unit 120 is configured to output a sound signal O1 based on a physical signal L1, in which the physical signal L1 corresponds to an original sound signal SI.

The base unit 140 is configured to output a sound signal O2 based on the original sound signal SI. As shown in FIG. 1, in some embodiments, the base unit 140 includes a maglev control module 141, a power supply module 142, and a processor 143. The maglev control module 141 is configured to generate the magnetic force M according to a current I1, so as to make the maglev unit 120 float on the base unit 140. The power supply module 142 is configured to receive power from AC mains or other external power sources (not shown), so as to provide an electrical energy to the device 100. The processor 143 is configured to control the power supply module 141 to output the current I1 to the maglev control module 141, and thus the maglev control module 141 can accordingly generate the magnetic force M. In various embodiments, the processor 143 is configured to monitor whether a current value of the current I1 is stable, so as to determine whether the magnetic force M generated by the maglev control module 141 is sufficient to make the maglev unit 120 stably float on the base unit 140. For example, the processor 143 can determine that the maglev unit 120 is stably floating on the base unit 140 when the current I1 is continuously within a predetermined current range (e.g., about 0.1-0.2 Ampere) for a predetermined time duration (e.g., about 3 seconds). The time for the predetermined time duration and the current value for the predetermined current range are given only for illustrative purposes, and the present disclosure is not limited thereto. A person of ordinary skill in the art can adjust these values depending on the actual application.

In various embodiments, after determining that the maglev unit 120 can stably float, the base unit 140 can provide the physical signal L1 to the maglev unit 120 via a first wireless transmission. At the same time, the processor 143 controls the power supply module 142 to provide electrical energy to the maglev unit 120 via a second wireless transmission, in which the first wireless transmission and the second wireless transmission are different. As a result, the maglev unit 120 can stably float on the base unit 140, and can play music for long periods through the supply of power from the base unit 140. Further, since the first wireless transmission and the second wireless transmission are different, mutual interference between the operations of power supply and music transmission can be prevented, and thus the resolution of the sound output from the device 100 can be improved.

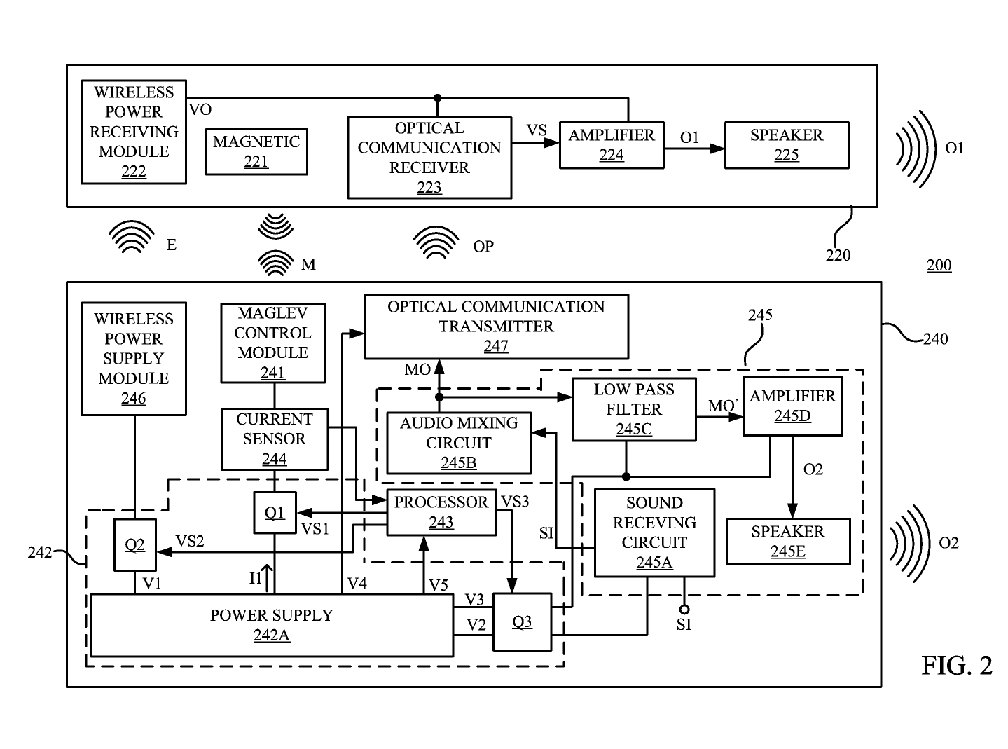

Reference is now made to FIG. 2. FIG. 2 is a schematic diagram of a device for playing music according to one embodiment of present disclosure. Compared with the previous embodiment, the base unit 240 of the device 200 further includes a current sensor 244, a sound processing module 245, a wireless power supply module 246, and an optical communication transmitter 247. The power supply module 242 includes a power supply 242A, a switch Q1, a switch Q2, and a switch Q3.

As shown in FIG. 2, the switch Q1 is coupled between the maglev control module 241 and the power supply 242A, and is configured to be selectively turned on to transmit the current I1 to the maglev control module 241 according to a switch signal VS1. Thus, the maglev control unit 241 can start to generate the magnetic force M. The current sensor 244 is coupled between the maglev control module 241 and the switch Q1, so as to monitor the current value of the current I1, and to transmit the sensed current value of the current I1 back to the processor 243. In some embodiments, the current sensor 244 can transmit the current value of the current I1 to the processor 243 via an inter-integrated circuit (I2C) bus. Such an example is only given for illustrative purposes, and any data bus able to perform the same function can be applied to the device 200. Thus, the present disclosure is not limited to the given example. When a floating position of the maglev unit 220 deviates from its intended position, the magnetic field generated by the maglev control module 241 receives interference, and thus the current I1 is varied. Therefore, through such a configuration, by determining whether the current value of the current I1 is stable, the processor 243 is able to instantaneously determine whether the maglev unit 220 is floating on the base unit 240 correctly.

Further, the switch Q2 is coupled between the wireless power supply module 246 and the power supply 242A, and is configured to be selectively turned on to transmit a voltage V1 to the wireless power supply module 246 according to a switching signal VS2, so as to drive the wireless power supply module 246. In other words, when the switch Q2 is turned on, the wireless power supply module 246 is enabled according to the voltage V1, and thus electrical energy E is transmitted to the maglev unit 220. In various embodiments, the wireless power supply module 246 can transmit the electrical energy E by using an inductive coupling effect, but the present disclosure is not limited in this regard.

As shown in FIG. 2, the switch Q3 is coupled between the sound processing module 245 and the power supply 245, and is configured to be selectively turned to transmit a voltage V2 and a voltage V3 according to a switching signal VS3, so as to drive the sound processing module 245. The sound processing module 245 can be driven by the voltage V2 and the voltage V3 to receive the original sound signal SI. Further, the sound processing module 245 can generate a monophonic signal MO, and output the sound signal O2 according to the monophonic signal MO.

In greater detail, the switch Q1, the switch Q2, and the switch Q3 are further coupled to the processor 243 to receive the switching signal VS1, the switch signal VS2, and the switching signal VS3, respectively. The processor 243 can determine the state of the switching signal VS2 and the switching signal VS3 by determining whether the current I1 is stable. The operation in this respect will be described in detail hereinafter. In addition, the power supply 242A is also configured to provide a voltage V4 and a voltage V5 to the optical communication transmitter 247 and the processor 243, respectively, so as to provide the power required by these elements.

As shown in FIG. 2, the sound processing module 245 includes a sound receiving circuit 245A, an audio mixing circuit 245B, a low pass filter 245C, an amplifier 245D, and a speaker 245E.

The sound receiving circuit 245A is driven by the voltage V2, and is configured to receive the original sound signal SI. In some embodiments, the sound receiving circuit 245A can receive the original sound signal SI via a wireless transmission protocol, such as Bluetooth. Alternatively, in some other embodiments, the signal source can transmit the original sound signal SI to the sound receiving circuit 245A via a wire. The audio mixing circuit 245B is configured to receive the original sound signal SI from the sound receiving circuit 245A, and to generate the monophonic signal MO accordingly. The low pass filter 245C and the amplifier 245D are driven by the voltage V3, in which the low pass filter 245C is configured to perform a low-pass filtering operation with respect to the monophonic signal MO, so as to output a sound signal MO′. In other words, the sound signal MO′ is a signal having low frequency components of the monophonic signal MO. The amplifier 245D is configured to amplify the sound signal MO′ to generate the sound signal O2. The speaker 245E can receive the sound signal O2 from the amplifier 245D, and output the same.

In addition, the optical communication transmitter 247 can receive the monophonic signal MO, and generate an optical signal OP according to the monophonic signal MO. The optical communication transmitter 247 then transmits the optical signal OP to the maglev unit 220.

With continued reference to FIG. 2, the maglev unit 220 includes a magnet 221, a wireless power receiving module 222, an optical communication receiver 223, an amplifier 224, and a speaker 225.

The magnet 221 is disposed corresponding in location to the maglev control module 241 of the base unit 240, so as to make the maglev unit 220 float on the base unit 240 according to the magnetic force M generated by the maglev control module 241. The wireless power receiving module 222 is disposed corresponding in location to the wireless power supply module 246, so as to receive the electrical energy E transmitted from the wireless power supply module 246. Thus, the wireless power receiving module 222 generates a voltage VO to drive the optical communication receiver 223 and the amplifier 224 according to the electrical energy E. The optical communication receiver 223 is disposed corresponding in location to the optical communication transmitter 247 to receive the optical signal OP, and generates a voltage signal VS according to the optical signal OP. The amplifier 224 is configured to amplify the voltage signal VS to generate the sound signal O1. The speaker 225 is coupled to the amplifier 224 to receive the sound signal O1 and output the same.

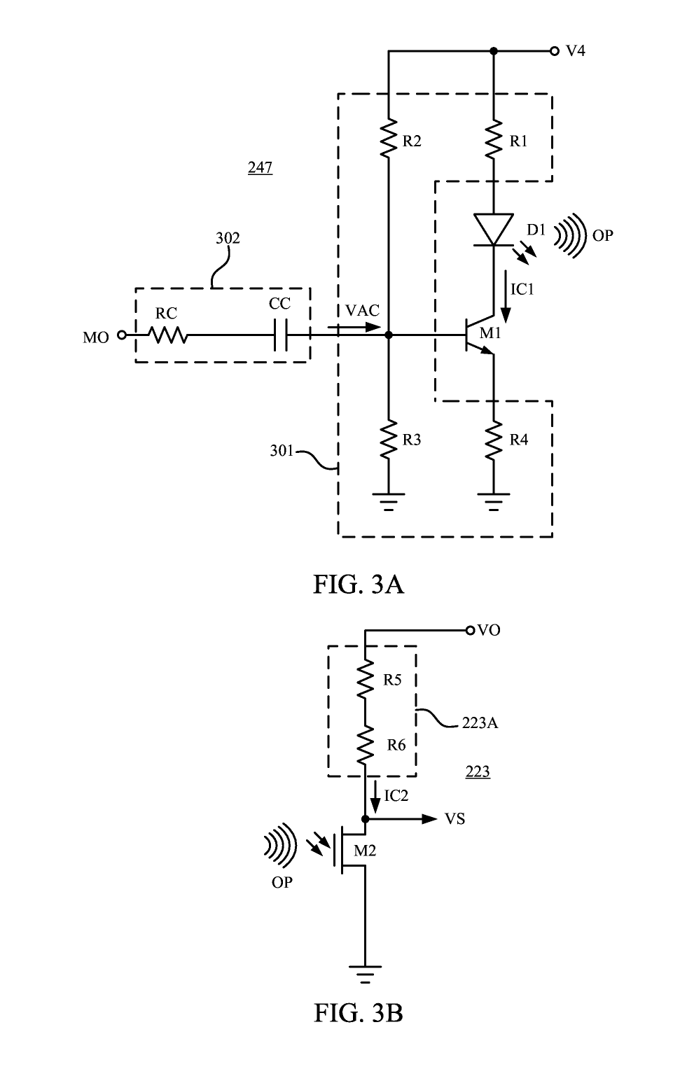

Reference is now made to FIG. 3A. FIG. 3A is a circuit diagram of the optical communication transmitter according to one embodiment of the present disclosure. As shown in FIG. 3A, the optical communication transmitter 247 includes a biasing circuit 301, an AC-coupling circuit 302, a transistor M1, and a light-emitting diode (LED) D1.

The biasing circuit 301 includes resistors R1-R4. A first terminal of the resistor R1 is coupled to the power supply 242A (see FIG. 2) to receive the voltage V4, and a second terminal of the resistor R1 is coupled to an anode of the LED D1. A first terminal of the resistor R2 is coupled to the power supply 242A (see FIG. 2) to receive the voltage V4, and a second terminal of the resistor R2 is coupled to a control terminal of the transistor M1. A first terminal of the resistor R3 is coupled to the second terminal of the resistor R2, and a second terminal of the resistor R3 is coupled to ground. A first terminal of the resistor R4 is coupled to the transistor M1, and a second terminal of the resistor R4 is coupled to ground. In regard to operation, the resistors R1-R4 are configured to bias the transistor M1 according to the voltage V4, so that the transistor M1 is operated in the active region.

The AC-coupling circuit 302 includes a resistor RC and a capacitor CC. The resistor RC and the capacitor CC are series-coupled between the audio mixing circuit 245B and the control terminal of the transistor M1, so as to receive the monophonic signal MO and generate a voltage signal VAC accordingly, in which the voltage signal VAC is the AC voltage signal of the monophonic signal MO.

As shown in FIG. 3A, a first terminal of the transistor M1 is coupled to a cathode of the LED D1. Since the transistor M1 is operated in the active region, the more the amplitude of the voltage signal VAC increases, the higher the output of a current IC1 by the transistor M1. As a result, a luminous intensity of the optical signal OP output from the LED D1 is increased. In other words, the voltage signal VAC is linearly proportional to the optical signal OP. With such a configuration, the monophonic signal MO can be linearly transformed into the optical signal OP through an opto-electronic conversion operation, and thus the optical signal OP can be transmitted to the optical communication receiver 223 of the maglev unit 220 via an optical communication.

Reference is made to FIG. 3B. FIG. 3B is a circuit diagram of the optical communication receiver according to one embodiment of the present disclosure. As shown in FIG. 3B, the optical communication receiver 223 includes a phototransistor M2 and a resistor circuit 223A. The resistor circuit 223A is coupled between a first terminal of the phototransistor M2 and the wireless power receiving module 222 (see FIG. 2) to receive a voltage VO. The resistor circuit 223A includes a resistor R5 and a resistor R6, in which the resistor R5 and the resistor R6 are series-coupled to the first terminal of the phototransistor M2 to output a voltage signal VS. A second terminal of the phototransistor M2 is coupled to ground, and a control terminal of the phototransistor M2 is configured to receive the optical signal OP. The phototransistor M2 generates a different current IC2 according to the optical signal OP. Through such operation, when the current IC2 passes through the resistor R5 and the resistor R6, the voltage signal VS is accordingly generated. The greater the luminous intensity of the optical signal OP, the higher the current IC2 and the lower the amplitude of the voltage signal VS. In other words, by such a configuration, the optical signal OP can be linearly transformed into the voltage signal VS that is the same as or close to the monophonic signal MO through an opto-electronic conversion operation. As a result, the amplifier 224 can be utilized to inversely amplify the voltage signal VS to output the sound signal O1.

According to the embodiments above, in this application, the monophonic signal MO is transmitted via the optical communication to prevent disturbance from the magnetic force M generated by the maglev control module 241 or the electrical energy E generated by the wireless power supply module 246. Moreover, as the delivery rate of the optical signal OP is very fast and the corresponding power consumption is very low, the sound signal O1 with a higher resolution can be obtained. The optical communication of the embodiments above is given only for illustrative purposes, and the present disclosure is not limited thereto. Other wireless transmissions for transmitting the physical signal L1 that are able to avoid interference from electromagnetic waves can also be used. A person having ordinary skill in the art can vary the transmission for the monophonic signal MO according to requirements of the actual application.

In some embodiments, as shown in FIG. 3A and FIG. 3B, by using the optical communication, the optical communication transmitter 247 and the optical communication receiver 223 can be implemented using a simple circuit architecture. Therefore, the device 200 can achieve a high resolution audio at a low cost.

In addition, since optical communication does not interfere with wireless charging, the maglev unit 200 is able to stably receive power via wireless charging, and thus the music playback time of the device 200 can be increased.

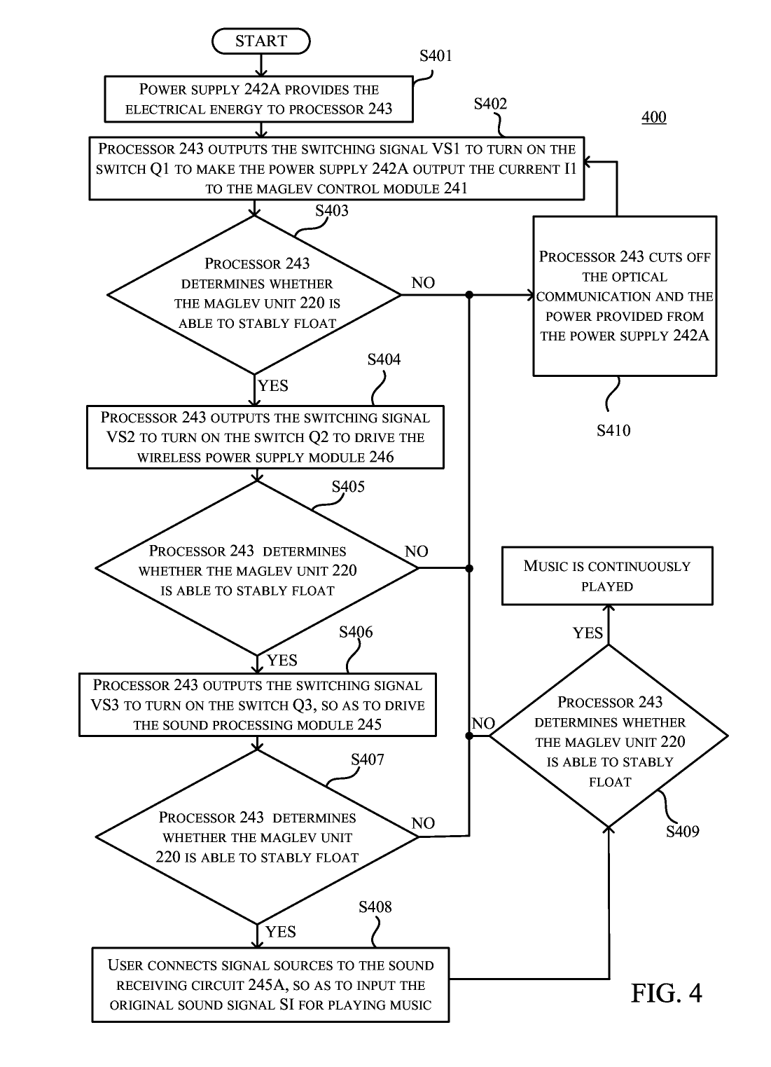

Reference is now made to FIG. 4. FIG. 4 is a flow chart of a control method according to one embodiment of the present disclosure. The control method 400 can be applied to the device 200 of FIG. 2. For simplicity, the operations of the device 200 of FIG. 2 are described with the control method 400.

As shown in FIG. 4, the control method 400 includes steps S401-S410. In step S401, after the device 200 is enabled, the power supply 242A provides electrical energy, i.e., the voltage V5, to the processor 243.

In step S402, the processor 243 outputs the switching signal VS1 to turn on the switch Q1, so as to make the power supply 242A output the current I1 to the maglev control module 241. As a result, the maglev control module starts to generate the magnetic force M according to the current I1, and thus the maglev unit 220 floats on the base unit 240.

In step S403, the processor 243 senses the current I1 via the current sensor 244 to determine whether the maglev unit 220 is able to stably float. If the maglev unit 220 is able to stably float, step S404 is performed. Otherwise, step S410 is performed.

For example, as stated above, when the floating position of the maglev unit 220 deviates, the current I1 is varied. Thus, the processor 243 can sense the current I1 by using the current sensor 244. When the current I1 is able to be continuously within a predetermined current range for the predetermined time duration, the processor accordingly determines that the maglev unit 220 is able to stably float, and thus the subsequent operations are performed.

In step S404, after a predetermined delay time, the processor 243 outputs the switching signal VS2 to turn on the switch Q2, so as to drive the wireless power supply module 246. Thus, the wireless power supply module 246 can transmit the electrical energy E to the maglev unit 220, so as to enable internal circuits of the maglev unit 220. In some embodiments, the predetermined delay time can be set to be about 0-3 seconds. However, it is noted that such values are only given for illustrative purposes, and the present disclosure is not limited thereto.

In step S405, the processor 243 senses the current I1 via the current sensor 244 to determine whether the maglev unit 220 is able to stably float. If the maglev unit 220 is able to stably float, step S406 is performed. Otherwise, step S410 is performed.

In step S406, the processor 243 outputs the switching signal VS3 to turn on the switch Q3, so as to drive the sound processing module 245.

In step S407, the processor 243 senses the current I1 via the current sensor 244 to determine whether the maglev unit 220 is able to stably float. If the maglev unit 220 is able to stably float, step S408 is performed. Otherwise, step S410 is performed.

In step S408, a user connects signal sources to the sound receiving circuit 245A, so as to input the original sound signal SI for playing music.

In step S409, the processor 243 senses the current I1 via the current sensor 244 to determine whether the maglev unit 220 is able to stably float. If the maglev unit 220 is able to stably float, the device 200 continuously plays the music. Otherwise, step S410 is performed.

In step S410, the processor 243 cuts off the optical communication and the power provided from the power supply 242A, and the operations of step S402 are performed. In other words, when the maglev unit 220 cannot stably float, the processor 243 resets the components of the base unit 240, and thus the maglev control module 241 can re-generate the magnetic force M.

By performing the control method 400, the processor 243 is able to instantaneously monitor the floating status of the maglev unit 200 by sensing the current I1. When the floating status is unstable, the processor 243 can reset the current operation by turning off the switch Q1 and the switch Q2. As a result, the reliability of the device 200 is improved.

The above embodiments are described with the device 200 having 1.1 channel, but the present disclosure is not limited thereto. A person having ordinary skill in the art can vary the channel number of the device 200 according to the actual application.

In summary, the device for playing music of the present disclosure utilizes different wireless transmissions to transmit electrical energy and music at the same time, and thus achieves a high resolution and a long playback time. Further, by continuously detecting variations in internal currents, the reliability of the device for playing music can be improved.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A device for playing music, comprising:
a maglev unit configured to output a first sound signal based on a physical signal corresponding to an original sound signal; and
a base unit configured to provide the physical signal to the maglev unit via a first wireless transmission, and to output a second sound signal based on the original sound signal, wherein the base unit comprises:
a maglev control module configured to generate a magnetic force according to a first current, so as to make the maglev unit float on the base unit;
a power supply module configured to supply power to the maglev control module; and
a processor configured to control the power supply module to output the first current, and to control the power supply module to supply an electrical energy to the maglev unit via a second wireless transmission when the first current is continuously within a predetermined current range for a predetermined time duration,
wherein the first wireless transmission and the second wireless transmission are different.

2. The device of claim 1, wherein the first wireless transmission comprises an optical communication, the physical signal comprises an optical signal, and the base unit further comprises:
an optical communication transmitter configured to generate the optical signal to the maglev unit according to a monophonic signal.

3. The device of claim 2, wherein the base unit further comprises:
a current sensor configured to detect the first current, and to transmit the first current to the processor;
a sound processing module configured to receive the original sound signal and generate the monophonic signal, wherein the sound processing module is further configured to output the second sound signal according to the monophonic signal; and
a wireless power supply module configured to provide the electrical energy to the maglev unit via the second wireless transmission.

4. The device of claim 2, wherein the power supply module comprises:
a first switch configured to selectively transmit the first current to the maglev control module according to a first switching signal;
a second switch configured to selectively transmit a first voltage to drive the wireless power supply module according to a second switching signal;
a third switch configured to selectively transmit at a least one second voltage to drive the sound processing module according to a third switching signal; and
a power supply configured to output the first current, the first voltage, and the least one second voltage.

5. The device of claim 2, wherein the processor is configured to generate the first switching signal, the second switching signal, and the third switching signal, and when the first current is continuously within the predetermined current range for the predetermined time duration, the processor outputs the second switching signal to turn on the second switch and outputs the third switching signal to turn on the third switch after a predetermined delay time.

6. The device of claim 5, wherein when one of the second switch and the third switch is turned on and the first current is not within the predetermined current range, the processor is further configured to output the second switching signal and the third switching signal to turn off the second switch and the third switch, respectively.

7. The device of claim 3, wherein the sound processing module comprises:
a sound receiving circuit configured to receive the original sound signal;
an audio mixing circuit configured to generate the monophonic signal;
a low pass filter configured to perform a low-pass filtering operation with respect to the monophonic signal;
an amplifier configured to generate the second sound signal by amplifying the low-pass filtered monophonic signal; and
a speaker configured to output the second sound signal.

8. The device of claim 2, wherein the optical communication transmitter comprises:
a biasing circuit coupled to the power supply module;
an AC-coupling circuit configured to receive the monophonic signal, and to output a voltage signal;
a transistor configured to be driven by the biasing circuit, and to output a second current according to the voltage signal; and
a light-emitting diode configured to generate the optical signal according to the second current.

9. The device of claim 3, wherein the maglev unit comprises:
a magnet disposed corresponding in location to the maglev control module;
an optical communication receiver disposed corresponding in location to the optical communication transmitter to receive the optical signal, and configured to generate a voltage signal according to the optical signal;
an amplifier configured to amplify the voltage signal to generate the first sound signal;
a wireless power receiving module disposed corresponding in location to the optical communication transmitter to receive the electrical energy, and configured to generate a voltage to drive the optical communication receiver and the amplifier according to the electrical energy; and
a speaker configured to output the first sound signal.

10. The device of claim 9, wherein the optical communication receiver comprises:
a phototransistor configured to generate a second current; and
a resistor circuit coupled between the phototransistor and the wireless power receiving module to transform the second current to the voltage signal.

11. The device of claim 5, wherein the predetermined delay time is configured to be about 0-3 seconds.

12. The device of claim 1, wherein the predetermined current range is configured to be about 0.1-0.2 Ampere.

13. The device of claim 1, wherein the predetermined time duration is configured to be about 3 seconds.

14. A control method for controlling a device for playing music, the device having a maglev unit and a base unit, and the control method comprising:
generating a magnetic force by a maglev control module of the base unit according to a first current, so as to make a maglev unit float on the base unit;
providing a physical signal corresponding to an original sound signal by the base unit to the maglev unit via a first wireless transmission, wherein the maglev unit is configured to output a sound signal according to the physical signal; and
supplying electrical energy by a power supply module of the base unit to the maglev unit via a second wireless transmission when the maglev unit stably floats on the base unit,
wherein the first wireless transmission and the second wireless transmission are different.

15. The control method of claim 14, further comprising:
sensing the first current by a current sensor of the base unit; and
controlling the power supply module by a processor of the base unit to supply the electrical energy when the first current is continuously within a predetermined current range for a predetermined time duration.

16. The control method of claim 15, wherein controlling the power supply module comprises:
turning on a first switch of the power supply module to transmit the first current according to a first switching signal;
turning on a second switch of the power supply module to transmit the first voltage to drive a wireless power supply module of the base unit according to a second switching signal; and
turning on a third switch of the power supply module to transmit at least one second voltage to drive a sound processing module of the base unit according to a third switching signal,
wherein the first switching signal, the second switching signal, and the third switching signal are generated by the processor when the first current is continuously within the predetermined current range for the predetermined time duration.

17. The control method of claim 16, wherein the physical signal is an optical signal, the first wireless transmission is an optical communication, and the providing the physical signal comprises:
generating a monophonic signal by the sound processing module according to the original sound signal;
generating the optical signal by an optical communication transmitter of the base unit according to the monophonic signal; and
transmitting the optical signal to an optical communication receiver of the maglev unit.

18. The control method of claim 16, further comprising:
turning off all of the first switch, the second switch, and the third switch by the processor when the first current is not continuously within the predetermined current range for the predetermined time duration.
